(19) United States
(12) Patent Application Publication
(10) Pub. No.: US 2019/0116321 A1
(43) Pub. Date: Apr. 18, 2019

(54) DOWNSTREAM SELECTABLE USER DEVICE DISPLAY OUTPUT

(71) Applicant: Microsoft Technology Licensing, LLC, Redmond, WA (US)

(72) Inventors: Gary Frank Grimm, Duvall, WA (US); Norman Taylor LeMieux, San Jose, CA (US)

(21) Appl. No.: 15/785,747

(22) Filed: Oct. 17, 2017

(51) Int. Cl. H04N 5/268; H04N 21/4363; H04N 21/414

(52) U.S. Cl. CPC H04N 5/268; H04N 21/41407; H04N 21/43635

(57) ABSTRACT

Dynamic display output techniques for computing systems and user devices are presented herein. Examples include downstream device-selectable outputs from a user device over a shared connector for HDMI and DisplayPort interfaces. In one example, a method of providing a display output from a user device includes detecting a downstream device communicatively coupled to the user device over a display connector. Responsive to detecting coupling of the downstream device, the method includes sensing a mode selection input by the downstream device through the display connector, and selectively providing at least video output over the display connector compatible with a preferred video interface indicated by the mode selection input.

### BACKGROUND

Various electronic user systems, such as computers, gaming systems, and media players, can include graphics/video output ports for displaying media content to users. For example, a computing system can provide various graphical user interface elements to a video monitor that displays the graphical user interface elements to a user. Gaming systems can interface with monitors, televisions, or head-mounted displays, among others. These user systems include video processor elements, such as graphics cards, graphics processing cores, as well as various interface circuitry and connectors. Many times, the graphics processing elements can support different display resolutions and may include many discrete ports or display connectors for producing video. However, having a fixed number or fixed type of display connectors can limit how users can connect various displays and downstream devices to these user systems.

### OVERVIEW

Dynamic display output techniques for computing systems and user devices are presented herein. Examples include downstream device-selectable outputs from a user device over a shared connector for HDMI and DisplayPort interfaces. In one example, a method of providing a display output from a user device includes detecting a downstream device communicatively coupled to the user device over a display connector. Responsive to detecting coupling of the downstream device, the method includes sensing a mode selection input by the downstream device through the display connector, and selectively providing at least video output over the display connector compatible with a preferred video interface indicated by the mode selection input.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a user device video output environment in an implementation.

FIG. 2 illustrates operation of a user device environment in an implementation.

FIG. 3 illustrates a user device environment in an implementation.

FIG. 4 illustrates user device output circuitry in an implementation.

FIG. 5 illustrates operation of a user device output service in an implementation.

### DETAILED DESCRIPTION

End user systems, such as gaming consoles, computing devices, set-top boxes, entertainment devices, and the like, can include display output capabilities to allow a user to interface with graphical elements, graphical user interfaces, view media content, or engage in virtual/augmented/mixed reality activities. Example implementations include gaming consoles, such as the Microsoft Xbox®, Xbox One®, or Xbox One X®, that enable simultaneous audio-visual (AV) streams to both a head mounted display (HMD) and a television (TV) for Virtual/Augmented/Mixed Reality scenarios.

Display outputs can be coupled to associated display devices, such as a video monitor, television, link repeater, or provided over network links or virtualized links. Although some display output elements can support different display modes over different physical ports or connectors, these display output elements typically only support one type of video mode or format over each physical connector. In the examples herein, enhanced functionality is provided to output at least two types of video or graphics types over a shared or common connector. The examples herein enable a source device to output video formats and modes over a standard output port by leveraging enhanced mechanisms and circuitry for a downstream device to control the upstream (source) device output format.

In many of the examples herein, a mode selection signal is provided to allow a downstream device to dynamically indicate a preferred audio/video mode of the source device. The downstream devices can dynamically switch between High-Definition Multimedia Interface (HDMI) and Video Electronics Standards Association (VESA) DisplayPort formats in many examples herein. However, different example modes or formats can instead be employed other than just these two specific modes. To provide this dynamic mode switching, an external pin can be employed for the downstream device to indicate the preferred mode to the source device. The HDMI ‘utility’ pin can be employed when the external connector comprises an HDMI connector. The HDMI utility pin comprises pin 14 of a Type-A HDMI connector, but other pins or connectors might instead be employed.

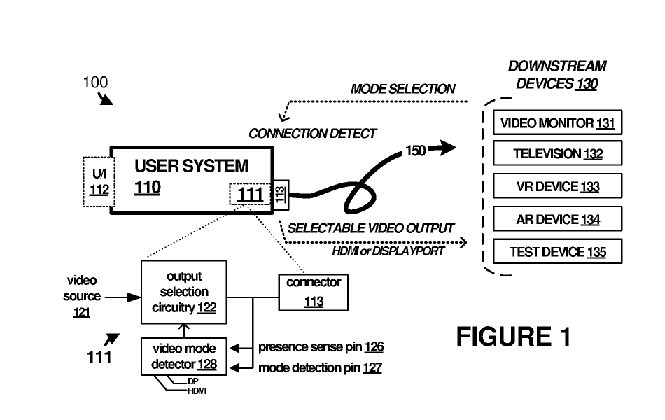

As a first example, FIG. 1 is provided. FIG. 1 illustrates a user device video output environment 100 in an implementation. Environment 100 includes user system 110 which can be coupled to various downstream devices 130. User system 110 can communicatively couple to video display devices over link 150. User system 110 includes mode selection service 111 and downstream device connector 113. Mode selection service 111 further includes output selection circuitry and video mode detector circuitry 128. User system 110 also include user interface system (U/I) 112, which is described below in more detail and typically employed by users to interact with various elements of user system 110 using graphical user interface elements.

In operation, a user may couple user system 110 to any selected downstream device 130, such as any among video monitors 131, televisions 132, projectors 133, virtual (VR) reality devices 133, augmented reality (AR) devices 134, or testing devices 135, among other display devices or display systems, including combinations thereof. Mode selection service 111 in user system 110 can detect an indication of an output mode selected by the downstream device and dynamically produce an output mode over a common connector 113 for at least distributing video or display output to the downstream device. Advantageously, various enhanced technical effects include providing users with a better display output experience that includes an enhanced downstream device-initiated mode switching among the supported output modes, such as among HMDI and DisplayPort without physical changes in connections or connector types. Moreover, support of multi-stream transport DisplayPort outputs over an HDMI connector can be supported.

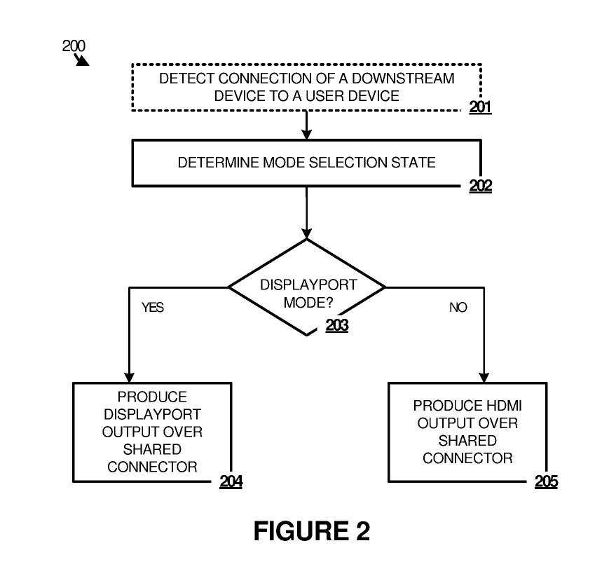

To further illustrate the operations of elements of environment 100, FIG. 2 is provided. In FIG. 2, a display or other downstream device, such as a VR headset, is connected to connector 113 of user system 110. Video mode detector 128 of mode selection service 111 detects (201) presence of this downstream device connection via presence sense pin 126. Presence sense pin 126 can comprise one or more pins of connector 113 which indicate presence of a downstream device, such as a “hot plug” detection pin or other device presence indication. It should be noted that operation 201 can be omitted in some examples.

The state of mode detection pin 127 is determined (202), which can indicate a selection by the downstream device (203). Mode detection pin 127 can comprise one or more pins of connector 113 which can be configured to relay a desired output mode selected by the downstream device. Various selections signals can be employed, and may be of any type agreed upon by the source device and downstream device. Specifically, at least two selection states must be defined and those states agreed upon. In many examples herein, the presence of a predetermined selection signal is defined as “request DisplayPort” and the absence of the selection signal is defined as “request HDMI.” When logical levels are employed as the selection signal, >3V can indicate presence of the selection signal, while <1V can indicate absence of the selection signals. More complex selection signals can be employed to ensure the mode switch is correctly recognized, such as a dynamic signal with a predetermined frequency (i.e. a predetermined number of toggles per second between high and low), and with a predetermined duty-cycle (i.e. a predetermined period indicating a first state is different from a predetermined period indicating a second state).

However, regardless of the selection signal employed, a first selection state can indicate a DisplayPort mode is selected by the downstream device, while a second selection state can indicate an HDMI mode is selected by the downstream device. Other modes can be supported, as well as multiple logic/voltage levels or other indication levels, but for this example only HDMI and DisplayPort modes are discussed. When the DisplayPort mode is selected via mode detection pin 127, output selection circuitry 122 produces (204) DisplayPort output over shared connector 113. When the HDMI mode is selected via mode detection pin 127, output selection circuitry produces (205) HDMI output over shared connector 113. The same or similar pins or connections are employed for both HDMI and DisplayPort outputs based at least on mode detection pin 127.

To produce the selected output mode, output selection circuitry 122 can produce output signals for use by a downstream device by at least modifying various aspects of a source video signal and other accompanying signals produced by video source 121 of user system 110. A source video signal can be produced by user system 110 to convey graphical information, video content, audio content, or other various information or data over a shared connector 113. Some example video source signals comprise analog or digital signaling, or specialized high-speed differential signaling formats, such as carried using a Transition-Minimized Differential Signaling (TMDS) format. The content, information, or data of the source signal can be conveyed to a downstream device using various formats or signaling levels compatible with the output formats, such as with HDMI or DisplayPort. Logic levels, signaling levels, impedances, or voltage levels can be altered according to the selected output mode. In addition, DC or AC coupling methods can be altered, and sideband signaling types can be selected among. Other aspects can be altered or selected among based at least on mode detection pin 127.

User system 110 can also determine properties from the downstream device in addition to using the mode detection pin 127 to select an output mode. These properties can be requested, read, or otherwise provided by the downstream device to user system 110, such as over link 150. These properties can include display model information, display type information, display descriptors, display identifiers, supported display resolutions, status information, display settings, color gamut information, or other information, including combinations thereof. In some examples, such as when link 150 carries HDMI or DisplayPort links, the properties can include Extended Display Identification Data (EDID). EDID includes data structures provided by a coupled digital display to describe associated capabilities to a display source, such as to user system 110. EDID can indicate various properties of the display device, such as display interface type, display make and model, display manufacturer name, display product codes, display year-of-manufacture, serial numbers, or other display identifiers or display identities.

Returning to a discussion of the elements of FIG. 1, user system 110 comprises an end user system, such as gaming systems, gaming consoles, virtual/augmented/mixed reality systems, terminals, computing devices, tablet devices, smartphones, personal computers, servers, cloud-based systems, distributed computing platforms, and the like. Users, such as users of a gaming system, entertainment platform, computing system can interact with user interface elements of user system 110 via user interface elements presented on any of video devices 130. User system 110 can receive user input via various user interface pathways, such as gaming controllers, touchscreens, mice, keyboards, speakers, microphones, virtual reality controllers, camera/imaging devices, and the like. User system 110 can include processing systems, memory systems, network interface equipment, user interface elements, audio and graphics processing systems, video handling systems, as well as video mode switching services, such as service 111.

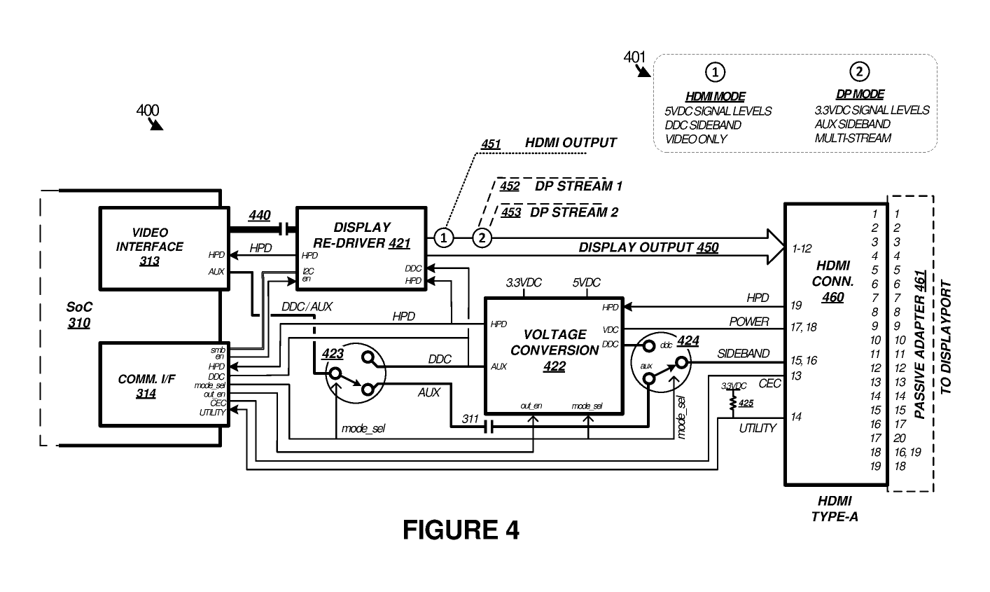

Mode switching service 111 comprises at least output selection circuitry 122 and video mode detector 128. FIG. 4 details example components employed in both output selection circuitry 122 and video mode detector 128. Output selection circuitry 122 comprises circuitry and various elements to switch among at least two video output modes for delivery to a downstream device. Output selection circuitry 122 comprises various analog and digital switching equipment, impedance matching circuitry, coupling circuitry, among other elements. Video mode detector 128 comprises monitoring elements, such as software or firmware elements, logic circuitry, or other elements to monitor states of one or more video mode selection pins. In some examples, portions of video mode detector 128 and output selection circuitry 122 are integrated into one or more processors or processing elements, peripheral control integrated circuitry, or other elements.

User interface device 112 receives user input from various input devices, such as one or more gaming controllers, keyboards, mouse devices, touch screens, touch panels, or other user input devices which can be used in combination with voice input, visual input, or other user input methods. This user input can be detected by user system 110 and translated into actions which can be interpreted by further elements of user system 110.

Downstream devices 130 can each comprise video monitors, televisions, projectors, touchscreens, transported video interfaces, virtualized interfaces, or other video or graphics viewing elements, including combinations thereof. Downstream devices 130 can include head-mounted displays which might provide Virtual Reality (VR), Augmented Reality (AR), or Mixed Reality (MR) elements. These head-mounted displays can include (or be used in conjunction with) headsets, projectors, glasses, or combinations thereof. Each display device can have one or more input interfaces for receiving graphics or audio-video signals from a source, such as from user system 110 over link 150.

Connector 113 can provide a physical coupling to user device 110 for link 150. Many of the examples herein configure connector 113 as an HDMI connector that can selectively carry HDMI signaling or DisplayPort signaling. Other examples employ a DisplayPort connector that can selectively carry HDMI signaling or DisplayPort signaling. Other link formats can be selected among. Link 150 can also use one or more cables or interconnect elements to communicatively couple user device 110 and a downstream device 130.

Link 150 comprises High-Definition Multimedia Interface (HDMI) or Video Electronics Standards Association DisplayPort in the examples herein. However, it should be understood that link 150 can include one or more further communication links, and comprise wireless or wired links. Link 150 can comprise various logical, physical, or application programming interfaces. Example links can use metal, glass, optical, air, space, or some other material as the transport media. In some examples, link 150 might include further portions that use various data protocols, such as Internet Protocol (IP), Ethernet, hybrid fiber-coax (HFC), WiFi (IEEE 802.11), Bluetooth, other wired or wireless data interfaces, or some other communication format, including combinations, improvements, or variations thereof. Link 150 can include direct links or may include intermediate networks, systems, or devices, and can include a logical network link transported over multiple physical links.

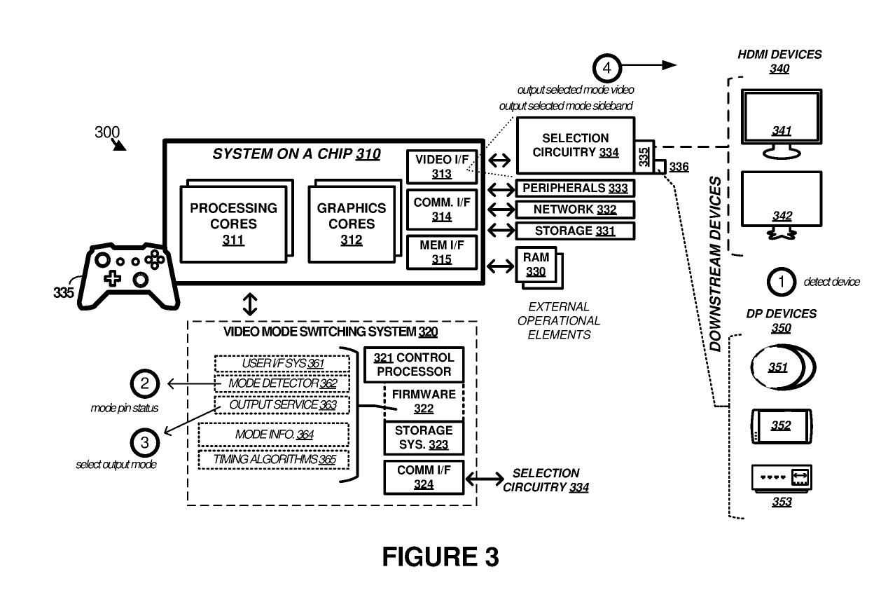

As a further example of display output switching techniques and implementations, FIG. 3 is provided. FIG. 3 is a system diagram illustrating user device environment 300. Environment 300 includes a system-on-a-chip (SoC) element along with other associated elements. Specifically, environment 300 includes SoC 310, video mode switching system 320, operational elements 330-333, selection circuitry 334, HDMI devices 340, and DisplayPort devices 350. HDMI port 335 and optional passive coupler 336 can be included as well. SoC 310 includes internal operational elements 311-315 comprising processing cores 311, graphics cores 312, video interface 313, communication interfaces 315, and memory interface 315. In some examples, portions of switching elements 334 are included in SoC 310. Video mode switching system 320 includes control processor 321, firmware 322, storage system 323, and communication interface 324.

Video mode switching system 320 might be implemented in portions of software, firmware, or hardware, including combinations thereof. Although the example in FIG. 3 illustrates firmware 322 as including functionality of video mode switching system 320, it should be understood that this functionality can instead be provided by selection circuitry 334, among other elements. Video mode switching system 320 can communicate with any of the elements of FIG. 3, such as selection circuitry 334, elements 330-333, internal SoC operational elements 311-315, and display devices 340/350. Operational elements 330-334 can communicate with SoC 310 over associated communication interfaces, and can receive power from associated power subsystems. SoC 310 and associated internal operational elements 311-315 can communicate internally over associated busses and communication interfaces, and can receive power over associated power links.

In the example where elements of environment 300 comprise a gaming system or entertainment device (such as a gaming console or virtual reality system) a user can couple the example system to a selected downstream device which might comprise a display device, television, projector, virtual reality device, virtual reality break-out box, augmented reality device, mixed reality device, testing device, or other equipment. Various example HDMI-compatible devices 341-342 and DisplayPort-compatible devices 351-353 are shown in FIG. 3. Devices 341-342 comprise video displays, monitors, televisions, or any other video or audio/video display. Device 351 comprises a user headset which might comprise a VR/AR headset, such as HoloLens or AR ‘glasses’ style of interface, although any display type might be employed. Example devices 352-353 can comprise VR breakout devices, manufacturing testing equipment, projectors, tablet or touchscreen devices, or other equipment.

These downstream devices can couple through selection circuitry 334 to SoC 310, which can include associated connectors, cabling, interface electronics, and other circuitry. Specifically, switching circuitry 334 can couple to any of devices 340 through HDMI connector 335. Switching circuitry 334 can also couple to any of devices 350 through HDMI connector 335 and (optionally) passive coupler 336. Passive coupler 336 can include pass-through electrical connections from a first connector type to a second connector type, such as from HDMI to DisplayPort.

Turning now to the operation of environment 300, mode detector 362 detects connection or initiation of a downstream device to SoC 310 via connector 335. For example, mode detector 362 can detect when any physical downstream device is coupled over an associated display link, which might include a physical coupling or connecting of a cable. Responsive to initiation of this display connection or coupling, mode detector 362 determines a mode selection made by the downstream device. Output service 363 selects a desired output mode and initiates a mode switching process with selection circuitry 334, which might include one more timing algorithms to ensure proper voltage settling time or interface switchover. Output service 363 can employ mode information 364 and timing algorithms 365 to perform the switchover processes among modes. Selection circuitry 334 responsively alters output pins or connections to carry the selected output mode, such as HDMI signaling or DisplayPort signaling over a shared set of pins. When connector 335 comprises an HDMI connector, then either HDMI signaling or DisplayPort signaling is selectively provided over the HDMI connector, according to a mode selection input of the coupled downstream device. When connector 335 comprises a DisplayPort connector, then either HDMI signaling or DisplayPort signaling is selectively provided over the DisplayPort connector, according to a mode selection input of the coupled downstream device.

Advantageously, various enhanced technical effects include providing users with an optimized video experience that includes providing selective video output over a common connector for both HDMI devices and DisplayPort devices. This selective video output is controlled in part by the downstream device which indicates a preferred output mode to the video source. Fewer connectors can be employed in user systems, and user systems that support more than one output mode over a shared physical connector can be provided.

Returning to a discussion of the elements of FIG. 3, video mode switching system 320 illustrates a control system that is representative of any system or collection of systems in which the various operational architectures, scenarios, and processes disclosed herein may be implemented. For example, video mode switching system 320 can be used to implement any of the control elements of FIG. 1, such as service 111.

Elements of SoC 310 and video mode switching system 320 can be implemented by various elements that include, but are not limited to, graphics processing subsystems, graphics controllers, graphics cards, device driver software, or graphics cores of computers, gaming systems, smartphones, laptop computers, tablet computers, desktop computers, server computers, hybrid computers, rack servers, web servers, cloud computing platforms, and data center equipment, as well as any other type of physical or virtual machine, and other computing systems and devices, as well as any variation or combination thereof. Video mode switching system 320 may be implemented as a single apparatus, system, or device or may be implemented in a distributed manner as multiple apparatuses, systems, or devices. Video mode switching system 320 includes, but is not limited to, control processor 321, firmware 322, storage system 323, and communication interface 324. Control processor 321 is operatively coupled with storage system 323 and communication interface system 324.

Control processor 321 loads and executes firmware 322 from storage system 323. Firmware 322 includes user interface system 361, mode detector 362, output service 363, mode information 364, and timing algorithms 365 which are representative of the processes, services, and platforms discussed with respect to the preceding Figures. Mode information 364 comprises data structures that hold various data associated with operations of firmware 322.

When executed by control processor 321 to provide enhanced video/graphics mode switching services, among other services, firmware 322 directs control processor 321 to operate as described herein for at least the various processes, operational scenarios, and sequences discussed in the foregoing implementations. Video mode switching system 320 may optionally include additional devices, features, or functionality not discussed for purposes of brevity.

Referring still to FIG. 3, control processor 321 may comprise a micro-processor and processing circuitry that retrieves and executes firmware 322 from storage system 323. In some examples, control processor 321 can be provided by one or more processing cores 311 of SoC 310. Control processor 321 may be implemented within a single processing device, but may also be distributed across multiple processing devices or sub-systems that cooperate in executing program instructions. Examples of control processor 321 include general purpose central processing units, application specific processors, and logic devices, as well as any other type of processing device, combinations, or variations thereof.

Storage system 323 may comprise any computer readable storage media readable by control processor 321 and capable of storing firmware 322. Storage system 323 can be provided, in some examples, by storage 331 and RAM 330, among other elements. Storage system 323 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 323 may also include computer readable communication media over which at least some of firmware 322 may be communicated internally or externally. Storage system 323 may be implemented as a single storage device, but may also be implemented across multiple storage devices or sub-systems co-located or distributed relative to each other. Storage system 323 may comprise additional elements, such as a controller, capable of communicating with control processor 321 or possibly other systems.

Firmware 322 may be implemented in program instructions and among other functions may, when executed by control processor 321, direct control processor 321 to operate as described with respect to the various operational scenarios, sequences, and processes illustrated herein. For example, firmware 322 may include program instructions for implementing enhanced video/graphics services, among other services. Firmware 322 can comprise portions of graphics/video device driver software in some examples, which might be employed to interface an operating system associated with processing cores 311 with any of graphics cores 312.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Firmware 322 may include additional processes, programs, or components, such as operating system software or other application software, in addition to or that including user interface system 361, mode detector 362, output service 363, mode information 364, and timing algorithms 365. Firmware 322 may also comprise firmware or some other form of machine-readable processing instructions executable by control processor 321.

In general, firmware 322 may, when loaded into control processor 321 and executed, transform a suitable apparatus, system, or device (of which video mode switching system 320 is representative) overall from a general-purpose computing system into a special-purpose computing system customized to provide enhanced video/graphics output mode switching services, among other services. Indeed, encoding firmware 322 on storage system 323 may transform the physical structure of storage system 323. The specific transformation of the physical structure may depend on various factors in different implementations of this description. Examples of such factors may include, but are not limited to, the technology used to implement the storage media of storage system 323 and whether the computer-storage media are characterized as primary or secondary storage, as well as other factors.

For example, if the computer readable storage media are implemented as semiconductor-based memory, firmware 322 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Turning now to the elements of firmware 322, mode detector 362 detects when a downstream device is connected or a downstream device interface is initiated and can determine a desired output mode indicated by the display or other downstream device. Output service 363 handles selecting an output mode from among mode information 364 and initiating any associated A/V signal, voltage, sideband, or coupling type switching performed in selection circuitry 334.

Mode information 364 may comprise three example categories of information. First, mode information 364 may define predetermined interface types, such as either HDMI or DP. Second, mode information 364 may include mode capabilities that the downstream device advertises from which the source device may choose, and this information can be used to present users with various related options. Third, mode information 364 may include a currently chosen mode/configuration that represents either defaults (prior to user input) or desired mode (after user input).

User interface system 361 provides various entry and modification user interface elements for initiating and altering contents of mode information 364 and timing algorithms 365. User interface system 361 can receive input and provide output over a programming interface, and can be carried over communication interface 324. User interface system 361 can comprise an application programming interface (API), or other programing interfaces. Mode information 364 includes one or more data structures relating supported output modes of selection circuitry 334 to various properties and control signals to be switched among, and timing relationships for control logic during switching processes. One or more timing algorithms 365 can be employed for switching modes or switching individual circuitry to select the various modes. Time delays or timing logic for various switching logic, stored in milliseconds or other time indications, can be stored timing algorithms 365.

Communication interface 324 may include communication connections and devices that allow for communication with various operational elements, user interfaces, SoC devices, display interfaces, display devices, or communication networks. Examples of connections and devices that together allow for inter-system communication may include system management interfaces, network interfaces, network interface cards, communication busses, antennas, RF circuitry, transceivers, and other communication circuitry. The connections and devices may communicate over communication media to exchange communications with other computing systems or networks of systems, such as metal, glass, air, or any other suitable communication media.

Communication between video mode switching system 320 and selection circuitry 334 can occur over at least communication interface 324. Communication interface 324 can be composed of elements of video interface 313, communication interface 314, and memory interface 315, or might comprise dedicated communication interfaces, pins, outputs, inputs, general-purpose input/outputs (GPIOs), or other elements. In some examples, communication interface 324 comprises a software, driver, or firmware portion of a video mode selection service, while communication interface 314 comprises a hardware or circuitry portion of the video mode selection service. For example, communication interface 324 might comprise an API or software interface that drives operation of communication interface 314 to affect operation of selection circuitry 334. Communication interface 314 can comprise southbridge circuitry, GPIOs, control logic, serial interfaces, or other interfaces. Direct or indirect communication may occur between communication interface 324 and selection circuitry 334, which can be transported over any communication network or networks and in accordance with various communication protocols, combinations of protocols, or variations thereof.

FIG. 4 illustrates user device output circuitry 400 in an implementation. FIG. 4 includes example implementations of portions of SoC 310, video mode switching system 320, and selection circuitry 344. Specifically, SoC 310 is pictured along with representative elements 313-314 which interface with further circuitry of FIG. 4 employed to implement an example of selection circuitry 334. HDMI connector 460 is employed in this implementation, and connector 460 comprises a Type-A style of HDMI connector, although other types of HDMI connectors can be employed. Two modes of operation of circuitry 400 are shown in FIG. 4, as indicated by mode descriptions 401 describing features of a first mode for HDMI and a second mode for DisplayPort. Other mode descriptions discussed herein are omitted from FIG. 4 for clarity, but might include AC/DC coupling, video data output capabilities, multi-stream capabilities, and other features discussed herein.

SoC 310 provides one or more video signals via video interface 313, which in this example comprises four pairs of video output indicated by link 440. Link 440 can comprise a dual-mode DisplayPort (DP++) interface with four high-speed differential pairs which may transport either HDMI Transition Minimized Differential Signal (TMDS) or DisplayPort Main Link (ML) protocols. Video interface 313 also outputs an auxiliary sideband interface (AUX) and can receive an indication of a hot plug detection (HPD) signal. Link 440 is provided to display re-driver 421 which can adjust properties of link 440 according to a mode selection indicated by a downstream device, as an output over HDMI connector 460 as display output 450.

Display re-driver 421 comprises a digital video interface (DVI) or high-definition multimedia interface (HDMI) signal input to level shifting re-driver. The re-driver function comprises a receiver and subsequent driver for each differential signal pair, where typically four differential signal pairs are employed to carry video information. HDMI signaling typically employs TMDS techniques, whereas DisplayPort video signaling typically employs low-voltage differential signaling (LVDS) techniques. Display re-driver 421 can be commanded to output signaling compatible with the selected video mode. Display re-driver 421 supports both AC-coupled and DC-coupled transmission modes. Display re-driver 421 can handle electrostatic discharge (ESD) protection for the associated signal lines, as well as signal isolation. In this example, display re-driver 421 has an AC-coupled input for the video signals, as denoted by the capacitor symbol within link 440.

In FIG. 4, display re-driver 421 can also support a Digital Display Control (DDC) interface, which supports the HDMI sideband communications at a 100 kilobit-per-second (Kbps) data rate. Display re-driver 421 can be controlled via system management bus (SMB) or inter-integrated circuit communication (I2C) signaling inputs and enable inputs. The enable function is controlled by a GPIO signal on communication interface 314 and allows for disabling of display output 450. Example display re-drivers include Texas Instruments integrated circuit SN75TDP158 HDMI 2.0 Re-Driver circuit.

In FIG. 4, HDMI output 451 can be carried over display output 450 when circuitry 400 is in an HDMI output mode, and one or more DisplayPort output streams (452-453) can be carried over display output 450 when circuitry 400 is in a DisplayPort mode. In-between mode switching, output signal 450 can be disabled during transition from one mode to another. Display re-driver 421 can also alter properties of output 450, such as capacitive coupling type, impedance levels, signal levels, transition rise/fall times, among other properties.

User device output circuitry 400 also includes voltage conversion module 422. Voltage conversion module 422 includes at least two voltage inputs that can be used to selectively drive output signals at a desired voltage level. In FIG. 4, these voltage levels are 3.3 VDC and 5 VDC, but other voltages can be used in further examples. When in an HDMI mode, voltage levels of 5 VDC are applied to certain output signals of voltage conversion module 422. When in a DisplayPort mode, voltage levels of 3.3 VDC are applied to certain output signals of voltage conversion module 422. Moreover, voltage conversion module 422 can provide power connections to HDMI connector 460 according to the selected mode, such as provided to pins 17 of HDMI connector 460. Pin 18 can be employed as a ground reference for the sideband signaling and as a power return for pin 17. Voltage conversion module 422 can also apply selected voltage levels to sideband signaling. Voltage conversion module 422 also is connected to hotplug detection (HPD) pin 19 of HDMI connector 460 in this example, and can filter, debounce, and alter a voltage level for further internal use of the HPD signal in circuitry 400. In FIG. 4, voltage conversion module 422 monitors an output enable (out_en) signal which enables output of various signals of voltage conversion module 422 according to selection indicated by communication interface 314, such as through a GPIO connection. A mode selection pin can also be included to indicate which mode among HDMI and DisplayPort is currently selected. In some examples, voltage conversion module 422 can include ST Microelectronics HDMI2C4-5F2 or HDMIDP1-5F6 voltage level modification circuits.

Sideband switches 423-424 provide selection among sideband signaling provided to HDMI connector 460 and other elements of circuitry 400. A mode selection signal (mode_sel) is based upon the downstream device selection indicator, and indicates which sideband signal should be passed to HDMI connector 460 and provided to a downstream device. Sideband switches 423-424 can comprise analog or digital switching elements, among other circuitry. In some examples, elements of sideband switches 423-424 are included in voltage conversion module 422 or other modules. When in a DP mode, switches 423-424 provide “AUX” style of sideband signaling associated with DisplayPort outputs, and when in an HDMI mode, switches 423-424 provide a DDC style of sideband signaling associated with HDMI outputs. The DDC style of sideband signaling is employed when in the HDMI mode and typically comprises I2C signaling, as mentioned above, that uses open drain bidirectional clock/data signals that are DC coupled. The AUX style of sideband signaling is AC coupled to HDMI connector 460 and employed in the DisplayPort mode. The AUX style of sideband signaling typically comprises bidirectional 1 MHz (or lower) signaling rates to convey device management data, video link sideband data, content protection data, and transport data in other protocols, such as various serial interfaces.

In FIG. 4, specific pinouts are employed on HDMI connector 460 to carry HDMI signaling when in the HDMI mode and to carry DisplayPort signaling when in the DisplayPort mode. Circuitry 400 can advantageously switch among the two modes among the same shared pins of connector 460 based on a selection made by a downstream device coupled to HDMI connector 460. In FIG. 4, pins 1-12 are employed for main video output signals and associated metadata output signals, whether using HDMI signaling or DisplayPort signaling. Pin 13 is employed for Consumer Electronics Control (CEC) commands in HDMI mode and can be employed for other purposes in DisplayPort mode. Pin 13 may be used for CEC even in DP mode for custom downstream devices where conversion exists back into HDMI. For example, SoC 310 may output DP Multi-Stream Transport (MST) over output 450, and an external device may accept this DP MST signaling, then de-multiplex two MST streams into DP Single-Stream Transport (SST) streams which can be converted to HDMI. The CEC signal would thus route around this circuitry and connect to one of those ports. Pins 15 and 16 are employed for sideband signaling, whether DDC or AUX style of sideband signaling. Pin 17 is employed for power and pin 18 for reference/ground, whether the power comprises 5 VDC for HDMI mode or 3.3 VDC for DisplayPort mode. Finally pin 19 is employed for hotplug detection, which indicates when a device is plugged into connector 460.

The HDMI utility pin is employed as the mode selection pin in FIG. 4 to allow a downstream device to select among the HDMI and DisplayPort modes, depending upon a selection signal that the downstream device indicates on the pin. A first selection signal can indicate the HDMI mode, and a second selection signal can indicate the DisplayPort mode. As seen in FIG. 4, pin 14 of HDMI connector 460 is employed in this configuration. A weak pull-up element 425 can be placed onto pin 14 of HDMI connector 460 to allow for mode selection by a downstream device and keep pin 14 into a known state when no downstream device is plugged in or when a downstream device does not make a selection (i.e. leaves pin 14 to float within the downstream device). Element 425 allows the downstream device to operate the selection signal at voltages that are unknown to circuitry 400 using an open-drain (OD) scheme, and element 425 sets the voltage level preferred by circuitry 400. The downstream device either grounds the signal (e.g. ‘low’ indicating a DP mode) or lets it float (e.g. ‘high’ indicating an HDMI mode), and circuitry 400 with element 425 sets the high voltage. The 3.3V shown on element 425 is an example, other examples include 2.5V, 2.0V, or even 1.5V. Element 425 can comprise a resistor, such as a 10 kilo-ohm resistor, or might comprise other similar components. Usage of pin 14 can vary depending upon the HDMI implementation and version, as well as the connector type. Typically, pin 14 on a type-A HDMI connector is reserved in HDMI versions 1.0-1.3c, employed as a utility/HEAC+ in HDMI versions 1.4 and later. Optionally, pin 14 can be employed in HDMI Ethernet Channel and Audio Return Channel implementations. However, when used as a mode selection pin as discussed herein, pin 14 will be dedicated to this mode selection function.

The HDMI utility pin is connected in circuitry 400 to communication interface 314, which can comprise a southbridge circuit or other circuitry. This southbridge or other circuitry may or may not be integrated into SoC 310. The input on communication interface 314 can comprise a system management mode (SMM) GPIO pin, which can also be ESD protected and operate using open-drain logic. Communication interface 314 and SoC 310 can include a display driver, which might comprise portions of video mode switching system 320 of FIG. 3. The display driver can be included in a host operating system (OS) that leverages an SMM GPIO pin to detect a specific signal. In this case, the HDMI utility pin signal can have properties comprising 1 kHz, 80% Duty Cycle, Open Drain, drive-strength of approximately 4 milliamps (mA), and 3.3V CMOS voltage levels, while having a pull-up element coupled to 3.3 VDC. The display driver can use detection of this HDMI utility pin signal to determine whether to enter an HDMI mode or DisplayPort mode upon rise/falling edges of the Hot Plug Detect (HPD) signal which is also introduced into communication interface 314 over another GPIO pin. Other examples might omit checking the HPD signal in conjunction with the HDMI utility pin. Communication interface 314 can thus leverage an SMM GPIO pin to detect an external mode indication signal via the aforementioned HDMI utility pin. Back-drive leakage protection can be implemented on this pin interface such that external voltages cannot leak into the leveraged 3.3V system voltage rail from HDMI connector 460. This single-pin interface can be protected against ESD and meet IEC 61000-4-2 Level 4 requirements.

To connect an HDMI downstream device, circuitry 400 configures pins on HDMI connector 460 for HDMI signaling, and HDMI connector 460 can be used natively. To connect a DisplayPort downstream device, circuitry 400 configures pins on HDMI connector 460 for DisplayPort signaling, and passive adapter 461 is employed in conjunction with HDMI connector 460. This passive connector can be employed by plugging the adapter into HDMI connector 460, as an adapter within the downstream device, or as an adapter included in cabling between HDMI connector 460 and the downstream device. However, all switching functionality for video signaling, sideband signaling, capacitive coupling style, and voltage levels is handled by circuitry 400 prior to output at HDMI connector 460. Thus, only a pinout conversion is employed and mechanical connector adapter is employed for passive adapter 461. Passive adapter 461 might include a pull-down element to couple pin 14 of HDMI connector 460 to ground, or other signaling circuitry to indicate the DP mode over pin 14 of HDMI connector 460. Although the pinout and configuration might vary in each implementation, no additional circuitry or voltage level conversion is employed in this example of passive adapter 461. For example, DisplayPort mode might omit connection to the CEC pin of connector 460. In other implementations, AC-coupling capacitors can be included on the high-speed differential pairs of display output 450, and on the AUX/DDC lines. Further examples could include a DC-DC conversion circuit to ensure that 3.3V is always provided at the DP receptacle interface of the adapter 461. The “passive” AC capacitors for TMDS/ML and AUX/DDC interfaces might be included in passive adapter 461 in addition to the mechanical conversion from HDMI to DP.

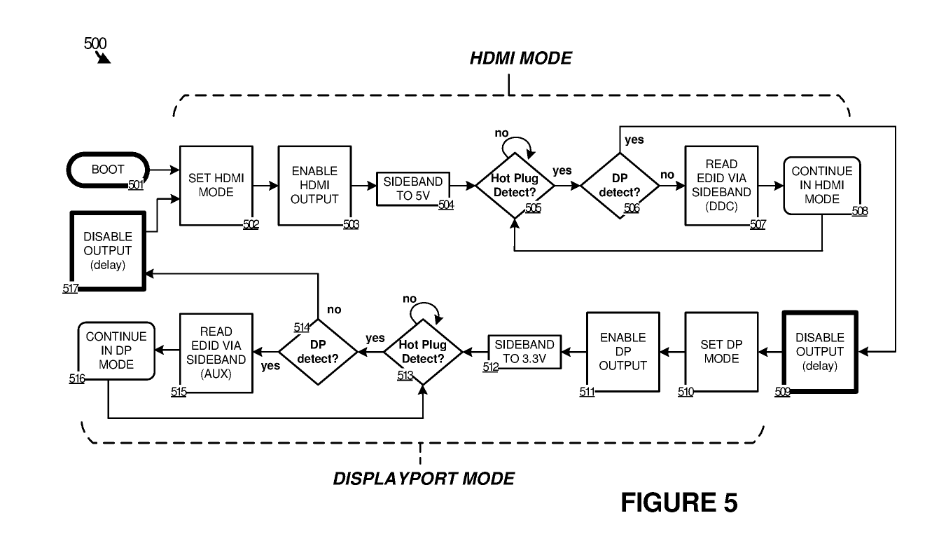

Turning now to further operation of the elements of FIGS. 3 and 4, FIG. 5 is presented. FIG. 5 is a flow diagram illustrating example operation in an implementation. The operations of FIG. 5 can be implemented by any of the systems described herein, such as video mode switching system 320 of FIG. 3 in conjunction with selection circuitry 344. Moreover, elements of circuitry 400 of FIG. 4 can be employed to implement portions of selection circuitry 344. In FIG. 5, a software host OS display driver, or other software/firmware element, can comprise a portion of a video mode switching system. For clarity, the operations of FIG. 5 will be discussed in the context of video mode switching system 320 and selection circuitry 344.

Video mode switching system 320 detects when a downstream device desires an output mode switch over an HDMI connector. This mode switch is among an HDMI mode and a DisplayPort mode, although other modes of operation can be supported. A trigger signal is employed to initiate the mode switch process, which is resultant from plugging in or powering on of a downstream device. A ‘hot plug detect’ pin is employed (indicated as HPD) to trigger sampling of an HDMI utility pin for mode determination. Video mode switching system 320 can drive associated mode switching circuitry to switch modes of video signaling, sideband signaling, voltage levels, and other properties to suit the selected output mode. Video mode switching system 320 can indicate this mode switch through one or more output GPIO pins that are routed to associated circuitry elements. In FIG. 5, these output GPIO pins include the out_en pin and the mode_sel pins.

Turning now to the operations of FIG. 5, an initial ‘boot’ state 501 initiates the process of setting the output circuitry into a default mode of operation, namely an HDMI output mode in operation 502. This HDMI output mode enables an HDMI output (503) of output circuitry, such as via display re-driver 421, and also configures associated sideband signaling to 5 VDC levels, such as using voltage conversion module 422. A selected sideband mode is also employed to correspond to the selected HDMI output mode (i.e. sideband signaling of DDC).

Video mode switching system 320 monitors (505) the HPD signal until an HPD signal transition, such as a rising or falling edge (depending upon implementation). When the rising edge is detected, video mode switching system 320 can switch modes if necessary. If no mode switch is necessary, such as already being in the desired mode (i.e. HDMI in this case), then video mode switching system 320 can remain in the HDMI mode (508) and can also read (507) HDMI device information via sideband signaling. This HDMI device information can include reading EDID information via the sideband signaling to determine various device properties. If a mode switch is desired, as indicated by the HDMI utility pin being driven by the downstream device into a new state than previously detected, then video mode switching system 320 can initiate the mode switch process. In this case, since the initial mode was HDMI and the desired state can be DisplayPort (506), then a mode switch to the DisplayPort mode can be initiated by video mode switching system 320.

To initiate the mode switching, first output signals are disabled (509) with a selectable delay. In this instance, the delay is 100 milliseconds (ms), but other delays can be established to ensure proper settling of associated signal lines with respect to the change in voltage levels or signaling techniques. This delay can allow for time to discharge excess charge that is back-driven onto lines that might share both 3.3 VDC and 5 VDC levels, so that when a 5V mode is transitioning to a 3.3V mode, excess charge has time to be drained from such lines. The actual time delay can be affected by line capacitances, parasitic capacitances, and other considerations.

After this delay has completed, then Video mode switching system 320 can initiate a setup of the DisplayPort mode (510). Video mode switching system 320 can drive associated mode switching circuitry to switch modes of video signaling, sideband signaling, voltage levels, and other properties to suit the selected output mode. Video mode switching system 320 can indicate this mode switch through one or more output GPIO pins that are routed to associated circuitry elements. In FIG. 5, these output GPIO pins include the out_en pin and the mode_sel pins. The DisplayPort outputs can then be enabled (511) via display re-driver 421, along with sideband voltages set to 3.3 VDC by voltage conversion module 422.

Video mode switching system 320 again monitors (513) the HPD signal until an HPD signal transition, such as a rising or falling edge (depending upon implementation). The HPD signal at the HDMI connector might not rise until after the associated power signal (such as DDC 5V) is turned on by circuitry 400. This allows the downstream device to identify that the video source is present (such as when DDC 5V is high), and the video source can responsively identify the presence of the downstream device. When the rising edge is detected, video mode switching system 320 can switch modes if necessary. If no mode switch is necessary, such as already being in the desired mode (i.e. DisplayPort in this case), then video mode switching system 320 can remain in the DisplayPort mode (516) and can also read (515) DisplayPort device information via sideband signaling. This DisplayPort device information can include reading EDID information via the sideband signaling to determine various device properties. If a mode switch is desired, as indicated by the HDMI utility pin being driven by the downstream device into a new state than previously detected, then video mode switching system 320 can initiate the mode switch process. In this case, since the present mode was DisplayPort and the desired state can be HDMI (514), then a mode switch to the HDMI mode can be initiated by video mode switching system 320.

To initiate the mode switching, output signals are disabled (517) with a selectable delay. In this instance, the delay is 100 milliseconds (ms), but other delays can be established to ensure proper settling of associated signal lines with respect to the change in voltage levels or signaling techniques. This delay can allow for time to transition voltage levels for sideband signaling as well as to allow for affected circuitry to switch modes. The actual time delay can be affected by line capacitances, parasitic capacitances, and other considerations. This process can then be repeated as necessary to provide both HDMI and DisplayPort mode changes over time.

Advantageously, the examples herein describe various enhanced systems, apparatuses, software, and circuitry to provide both HDMI and DisplayPort signaling over the same connector pins. The downstream device, such as a display, VR device, or testing apparatus, can select—via a discrete pin—the preferred output mode of the video source. When in the HDMI mode, various video signaling, sideband signaling, capacitive coupling style, voltage levels, and other properties for HDMI are employed over an HDMI connector. When in the DisplayPort mode, various video signaling, sideband signaling, capacitive coupling style, voltage levels, and other properties for DisplayPort are employed over the HDMI connector. A passive coupler or adapter can be used to plug native DisplayPort devices into the HDMI connector. However, no rework or active adaption is required to selectively support both modes through the same connector.

When in the DisplayPort mode, any DisplayPort features can be supported, such as more than one transport stream via DisplayPort Multi-Stream Transport, among other DP features. Based at least on the output mode comprising the DisplayPort mode, the user system can provide DisplayPort-compatible output over the HDMI display connector, where the DisplayPort-compatible output comprises at least a first output stream and a second output stream over the HDMI connector. The HDMI connector can carry DisplayPort streams to a DisplayPort-compatible device. The multiple streams can be useful when VR/AR/MR devices are employed, so that a first warped video representation stream can be provided to a user wearing glasses/goggles, while a second simultaneous non-warped version can be provided for spectators watching via a projector or television/monitor. In another example of multiple streams, a first DisplayPort video output stream is provided over the HDMI connector for a head-mounted display (such as a VR/AR/MR device), and a secondary DisplayPort video output stream is also provided over the HDMI connector. This secondary DisplayPort video output stream can be unique from the first DisplayPort video output stream, or comprise different video content. The first DisplayPort video output stream might be for a first-person viewpoint, while the second DisplayPort video output stream might be for an audience or third-person viewpoint, composite views, map views, overhead views, or other video output streams. However, when multiple DisplayPort output streams are employed, these outputs are carried over an HDMI connector.

In further examples, enhanced testing of a user system can be achieved. A testing fixture or apparatus can be coupled to a single HDMI connector of a user system, and both HDMI signaling and DisplayPort signaling can be provided during testing procedures. The HDMI output can be used to test various video outputs, and the DisplayPort can be employed to test eye contours for manufacturing test/qualification testing. The DisplayPort output can be more configurable to output desired test data for determining signal quality during testing. Thus, DisplayPort signaling output can be employed over an HDMI connector to test the HDMI connector for signal integrity, signal quality, and evaluation of channel noise and intersymbol interference. Further debug use cases can be employed where DP multistream transport can be used to transmit raw performance data for an associated CPU/GPU system to help with game and application development. This raw performance data can comprise data related to the performance of the game console system from a graphics/processing point of view.

Certain inventive aspects may be appreciated from the foregoing disclosure, of which the following are various examples.

### Example 1

A method of providing a display output from a user device, the method comprising detecting a downstream device communicatively coupled to the user device over a display connector. Responsive to detecting coupling of the downstream device, the method includes sensing a mode selection input by the downstream device through the display connector, and selectively providing at least video output over the display connector compatible with a preferred video interface indicated by the mode selection input.

### Example 2

The method of Example 1, further comprising detecting a state of at least the mode selection input on the display connector, where a first state indicates a first preferred video interface, and where a second state indicates a second preferred video interface.

### Example 3

The method of Examples 1-2, where the first preferred video interface comprises a High-Definition Multimedia Interface (HDMI) video interface, and where the second preferred video interface comprises a DisplayPort video interface, and where both the HDMI video interface and the DisplayPort interface are alternatively provided over one or more shared pins of the display connector based at least on the state of the mode selection input.

### Example 4

The method of Examples 1-3, where the display connector comprises a High-Definition Multimedia Interface (HDMI) connector, and where the video output comprises an output mode selected among an HDMI mode and a DisplayPort mode selectively provided over one or more shared pins of the HDMI connector.

### Example 5

The method of Examples 1-4, further comprising, based at least on the output mode comprising the DisplayPort mode, providing DisplayPort-compatible output over the display connector, wherein the DisplayPort-compatible output comprises at least a first output stream for a head mounted display device and a secondary video output stream over the HDMI connector.

### Example 6

The method of Examples 1-5, where the display connector comprises a High-Definition Multimedia Interface (HDMI) connector, and wherein the video output comprises at least two DisplayPort output streams comprising content that varies among the at least two DisplayPort output streams.

### Example 7

The method of Examples 1-6, further comprising selectively providing at least the video output compatible with the preferred video interface over the display connector by switching shared video output pins on the display connector to be compatible with one among a High-Definition Multimedia Interface (HDMI) mode and a DisplayPort mode.

### Example 8

The method of Examples 1-7, further comprising selectively providing sideband communication signaling compatible with the preferred video interface over the display connector by switching shared sideband output pins on the display connector to carry one among the HDMI mode and the DisplayPort mode.

### Example 9

The method of Examples 1-8, further comprising selectively providing voltage levels for the preferred video interface over the display connector to be compatible with the selected one among the HDMI mode and the DisplayPort mode.

### Example 10

A video output system for a user device, comprising a video mode detector configured to detect a downstream device communicatively coupled to the user device over a display connector. Responsive to detecting coupling of the downstream device, the video mode detector is configured to sense a mode selection input by the downstream device through the display connector. Output selection circuitry is configured to selectively provide at least video output over the display connector compatible with a preferred video interface indicated by the mode selection input.

### Example 11

The video output system of Example 10, comprising the video mode detector configured to detect a state of at least the mode selection input on the display connector, where a first state indicates a first preferred video interface, and where a second state indicates a second preferred video interface.

### Example 12

The video output system of Examples 10-11, where the first preferred video interface comprises a High-Definition Multimedia Interface (HDMI) video interface, and where the second preferred video interface comprises a DisplayPort video interface, and where both the HDMI video interface and the DisplayPort interface are alternatively provided over one or more shared pins of the display connector based at least on the state of the mode selection input.

### Example 13

The video output system of Examples 10-12, where the display connector comprises a High-Definition Multimedia Interface (HDMI) connector, and where the video output comprises an output mode selected among an HDMI mode and a DisplayPort mode selectively provided over one or more shared pins of the HDMI connector.

### Example 14

The video output system of Examples 10-13, comprising based at least on the output mode comprising the DisplayPort mode, the output selection circuitry configured to provide DisplayPort-compatible output over the display connector, wherein the DisplayPort-compatible output comprises at least a primary head mounted display output stream and a secondary output stream over the HDMI connector.

### Example 15

The video output system of Examples 10-14, where the display connector comprises a High-Definition Multimedia Interface (HDMI) connector, and wherein the video output comprises at least two DisplayPort output streams comprising content that varies among the at least two DisplayPort output streams.

### Example 16

The video output system of Examples 10-15, comprising the output selection circuitry configured to selectively provide at least the video output compatible with the preferred video interface over the display connector by switching shared video output pins on the display connector to be compatible with one among a High-Definition Multimedia Interface (HDMI) mode and a DisplayPort mode.

### Example 17

The video output system of Examples 10-16, comprising the output selection circuitry configured to selectively provide sideband communication signaling compatible with the preferred video interface over the display connector by switching shared sideband output pins on the display connector to carry one among the HDMI mode and the DisplayPort mode.

### Example 18

The video output system of Examples 10-17, comprising the output selection circuitry configured to selectively provide voltage levels for the preferred video interface over the display connector to be compatible with the selected one among the HDMI mode and the DisplayPort mode.

### Example 19

A display output control apparatus for a user device, comprising one or more computer readable storage media, a processing system operatively coupled with the one or more computer readable storage media, and a video selection service comprising program instructions stored on the one or more computer readable storage media. Based on being read and executed by the processing system, the program instructions direct the processing system to at least detect a downstream device communicatively coupled to the user device over a High-Definition Multimedia Interface (HDMI) display connector of the user device. Responsive to detecting coupling of the downstream device, video selection service is configured to sense a mode selection input by the downstream device through the HDMI display connector, where the mode selection indicates a preferred video interface of the downstream device among an HDMI interface and DisplayPort interface, instruct output circuitry to provide at least video output over the HDMI display connector compatible with the preferred video interface indicated by the mode selection input.

### Example 20

The display output control apparatus of Example 19, comprising further program instructions, that when executed by the processing system, direct the processing system to at least instruct the output circuitry to provide sideband communication signaling over the HDMI display connector by switching shared sideband output pins on the display connector to carry with one among the HDMI interface and the DisplayPort interface, and instruct the output circuitry to provide voltage levels and capacitive coupling types over the HDMI display connector to be compatible with the selected one among the HDMI mode and the DisplayPort mode.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the subject matter of this application. Those skilled in the art will also appreciate that the features described above can be combined in various ways to form multiple implementations. As a result, the invention is not limited to the specific implementations described above, but only by the claims and their equivalents.

1. A method of providing a display output from a user device, the method comprising:
detecting a downstream device communicatively coupled to the user device over a High-Definition Multimedia Interface (HDMI) display connector;
responsive to detecting coupling of the downstream device, sensing a mode selection input presented on a utility pin of the HDMI display connector by the downstream device through the HDMI display connector; and
selectively providing at least video output over the HDMI display connector compatible with a preferred video interface indicated by the mode selection input.

2. The method of claim 1, wherein the utility pin of the HDMI display connector comprises pin 14 of a Type-A HDMI connector, and further comprising:
detecting a state of at least the mode selection input on the HDMI display connector, wherein a first state indicates a first preferred video interface, and wherein a second state indicates a second preferred video interface.

3. The method of claim 2, wherein the first preferred video interface comprises a High-Definition Multimedia Interface (HDMI) video interface, and wherein the second preferred video interface comprises a DisplayPort video interface, and wherein both the HDMI video interface and the DisplayPort interface are alternatively provided over one or more shared pins of the HDMI display connector based at least on the state of the mode selection input.

4. The method of claim 1, wherein the video output comprises an output mode selected among an HDMI mode and a DisplayPort mode selectively provided over one or more shared pins of the HDMI connector.

5. The method of claim 4, further comprising:
based at least on the output mode comprising the DisplayPort mode, providing DisplayPort-compatible output over the HDMI display connector, wherein the DisplayPort-compatible output comprises at least a first output stream for a head mounted device and a secondary video output stream over the HDMI connector.

6. The method of claim 1, wherein the video output comprises at least two DisplayPort output streams comprising content that varies among the at least two DisplayPort output streams.

7. The method of claim 1, further comprising:
selectively providing at least the video output compatible with the preferred video interface over the HDMI display connector by switching shared video output pins on the HDMI display connector to be compatible with one among a High-Definition Multimedia Interface (HDMI) mode and a DisplayPort mode.

8. The method of claim 7, further comprising:
selectively providing sideband communication signaling compatible with the preferred video interface over the HDMI display connector by switching shared sideband output pins on the HDMI display connector to carry one among the HDMI mode and the DisplayPort mode.

9. The method of claim 7, further comprising:
selectively providing voltage levels for the preferred video interface over the HDMI display connector to be compatible with the selected one among the HDMI mode and the DisplayPort mode.

10. A video output system for a user device, comprising:
a video mode detector configured to detect a downstream device communicatively coupled to the user device over a High-Definition Multimedia Interface (HDMI) display connector;
responsive to detecting coupling of the downstream device, the video mode detector configured to sense a mode selection input presented on a utility pin of the HDMI display connector by the downstream device through the HDMI display connector; and
output selection circuitry configured to selectively provide at least video output over the HDMI display connector compatible with a preferred video interface indicated by the mode selection input.

11. The video output system of claim 10, wherein the utility pin of the HDMI display connector comprises pin 14 of a Type-A HDMI connector, and ‘comprising:
the video mode detector configured to detect a state of at least the mode selection input on the HDMI display connector, wherein a first state indicates a first preferred video interface, and wherein a second state indicates a second preferred video interface.

12. The video output system of claim 11, wherein the first preferred video interface comprises a High-Definition Multimedia Interface (HDMI) video interface, and wherein the second preferred video interface comprises a DisplayPort video interface, and wherein both the HDMI video interface and the DisplayPort interface are alternatively provided over one or more shared pins of the HDMI display connector based at least on the state of the mode selection input.

13. The video output system of claim 10, wherein the video output comprises an output mode selected among an HDMI mode and a DisplayPort mode selectively provided over one or more shared pins of the HDMI connector.

14. The video output system of claim 13, comprising:
based at least on the output mode comprising the DisplayPort mode, the output selection circuitry configured to provide DisplayPort-compatible output over the HDMI display connector, wherein the DisplayPort-compatible output comprises at least a head mounted display output stream and a secondary output stream over the HDMI connector.

15. The video output system of claim 10, wherein the video output comprises at least two DisplayPort output streams comprising content that varies among the at least two DisplayPort output streams.

16. The video output system of claim 10, comprising:
the output selection circuitry configured to selectively provide at least the video output compatible with the preferred video interface over the HDMI display connector by switching shared video output pins on the HDMI display connector to be compatible with one among a High-Definition Multimedia Interface (HDMI) mode and a DisplayPort mode.

17. The video output system of claim 16, comprising:
the output selection circuitry configured to selectively provide sideband communication signaling compatible with the preferred video interface over the HDMI display connector by switching shared sideband output pins on the HDMI display connector to carry one among the HDMI mode and the DisplayPort mode.

18. The video output system of claim 16, comprising:
the output selection circuitry configured to selectively provide voltage levels for the preferred video interface over the HDMI display connector to be compatible with the selected one among the HDMI mode and the DisplayPort mode.

19. A display output control apparatus for a user device, comprising:
one or more computer readable storage media;
a processing system operatively coupled with the one or more computer readable storage media; and
a video selection service comprising program instructions stored on the one or more computer readable storage media that, based on being read and executed by the processing system, direct the processing system to at least:
detect a downstream device communicatively coupled to the user device over a High-Definition Multimedia Interface (HDMI) display connector of the user device;
responsive to detecting coupling of the downstream device, sense a mode selection input on pin 14 of the HDMI display connector made by the downstream device through the HDMI display connector, wherein the mode selection indicates a preferred video interface of the downstream device among an HDMI interface and DisplayPort interface; and
instruct output circuitry to provide at least video output over the HDMI display connector compatible with the preferred video interface indicated by the mode selection input.

20. The display output control apparatus of claim 19, comprising further program instructions, that when executed by the processing system, direct the processing system to at least:
instruct the output circuitry to provide sideband communication signaling over the HDMI display connector by switching shared sideband output pins on the HDMI display connector to carry with one among the HDMI interface and the DisplayPort interface; and
instruct the output circuitry to provide voltage levels and capacitive coupling types over the HDMI display connector to be compatible with the selected one among the HDMI mode and the DisplayPort mode.
